(19) United States
(12) Patent Application Publication
(10) Pub. No.: US 2026/0153637 A1
(43) Pub. Date: Jun. 4, 2026

(54) SEISMIC WAVEFIELD DECOMPOSITION USING RECURSIVE RADON TRANSFORM

(71) Applicant: SAUDI ARABIAN OIL COMPANY, Dhahran (SA)

(72) Inventor: Lu Liu, Beijing (CN)

(73) Assignees: ARAMCO FAR EAST (BEIJING) BUSINESS SERVICES CO., LTD., Beijing (CN); SAUDI ARABIAN OIL COMPANY, Dhahran (SA)

(21) Appl. No.: 18/718,272

(22) PCT Filed: Aug. 25, 2023
(86) PCT No.: PCT/CN2023/115019

§ 371 Date: Jun. 10, 2024

(51) Int. Cl. G01V 1/00; G01V 1/30; G01V 1/36

(52) U.S. Cl. CPC G01V 1/325; G01V 1/301; E21B 44/00; G01V 2210/1425; G01V 2210/46; G01V 2210/51; G01V 2210/57; G01V 2210/614; G01V 2210/624

(57) ABSTRACT

The methods may include obtaining a frequency-domain seismic wavefield associated to grid points and organized into slices. Each slice is organized into a sequence of overlapping windows. The methods may further include, for each slice, determining a value of a first intermediate function using the frequency-domain seismic wavefield for each grid point in a first overlapping window, determining a value of the first intermediate function using the frequency-domain seismic wavefield for each incremental grid point in each n-th overlapping window, where n is an integer greater than one, and determining a value of the first intermediate function by selecting the previously-determined value of the first intermediate function for each common grid point in each n-th overlapping window. The methods may still further include determining, using a second intermediate function, a Radon-transformed seismic wavefield using the value of the first intermediate function for the grid points. A non-transitory computer-readable memory and systems are also disclosed.

### BACKGROUND

In the oil and gas industry, a seismic survey may be conducted over a subterranean region of interest to characterize the subsurface and locate hydrocarbon reservoirs within the subterranean region of interest. During the seismic survey, a seismic source generates seismic waves that propagate through the subterranean region of interest. In a land environment, the vibrations of the earth caused by the seismic waves are detected by seismic receivers. The seismic receivers store this vibration information as amplitude-versus-time data known as seismic traces. The collection of seismic traces recorded during the seismic survey may be known as a seismic wavefield.

The seismic wavefield may not be immediately useful to characterize the subsurface and locate hydrocarbon reservoirs. To do so, the seismic wavefield may be processed. Seismic processing includes a series of processing steps designed to correct for anomalies such as near-surface effects, noise, seismic survey geometry irregularities, acoustic illusions, etc. If the subterranean region of interest includes complex geological structures, the seismic processing step of migration may be applied to the seismic wavefield. Migration may aim to correctly position complex geological structures that manifest at incorrect positions within the seismic wavefield. Complex geological structures may include, without limitation, reefs, ancient river channels, faults, fractures, geological boundaries, salt domes, and hydrocarbon reservoirs. In turn, a migrated seismic image may be a more reasonable characterization of the subterranean region of interest.

Once the seismic wavefield is adequately processed, the resulting migrated seismic image and/or attributes of the processed seismic wavefield may be used to characterize the subsurface and locate hydrocarbon reservoirs within the subterranean region of interest. In turn, a wellbore path may be planned and drilled to penetrate a located hydrocarbon reservoir to ultimately produce hydrocarbons to the surface for use.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining a frequency-domain seismic wavefield associated to grid points and organized into slices. Each slice is organized into a sequence of overlapping windows. The methods may further include, for each slice, determining a value of a first intermediate function using the frequency-domain seismic wavefield for each grid point in a first overlapping window, determining a value of the first intermediate function using the frequency-domain seismic wavefield for each incremental grid point in each n-th overlapping window, where n is an integer greater than one, and determining a value of the first intermediate function by selecting the previously-determined value of the first intermediate function for each common grid point in each n-th overlapping window. The methods may still further include determining, using a second intermediate function, a Radon-transformed seismic wavefield using the value of the first intermediate function for the grid points.

In general, in one aspect, embodiments relate to a non-transitory computer-readable memory having computer-executable instructions stored thereon that, when executed by a computer processor, performs steps including receiving a frequency-domain seismic wavefield associated to grid points and organized into slices. Each slice is organized into a sequence of overlapping windows. The steps further include, for each slice, determining a value of a first intermediate function using the frequency-domain seismic wavefield for each grid point in a first overlapping window, determining a value of the first intermediate function using the frequency-domain seismic wavefield for each incremental grid point in each n-th overlapping window, where n is an integer greater than one, and determining a value of the first intermediate function by selecting the previously-determined value of the first intermediate function for each common grid point in each n-th overlapping window. The steps still further include determining, using a second intermediate function, a Radon-transformed seismic wavefield using the value of the first intermediate function for the grid points.

In general, in one aspect, embodiments relate to a system. The system includes a seismic processing system configured to receive a frequency-domain seismic wavefield associated to grid points and organized into slices. Each slice is organized into a sequence of overlapping windows. The seismic processing system is further configured to, for each slice, determine a value of a first intermediate function using the frequency-domain seismic wavefield for each grid point in a first overlapping window, determine a value of the first intermediate function using the frequency-domain seismic wavefield for each incremental grid point in each n-th overlapping window, where n is an integer greater than one, and determine a value of the first intermediate function by selecting the previously-determined value of the first intermediate function for each common grid point in each n-th overlapping window. The seismic processing system is still further configured to determine, using a second intermediate function, a Radon-transformed seismic wavefield using the value of the first intermediate function for the grid points and determine a migrated seismic image using the frequency-domain seismic wavefield and the Radon-transformed seismic wavefield. The system further includes a seismic interpretation workstation configured to determine a location of a hydrocarbon reservoir within a subterranean region of interest using the migrated seismic image, where the subterranean region of interest is represented by the grid points.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIG. 2 displays a seismic velocity model in accordance with one or more embodiments.

FIGS. 3A and 3B display a portion of a simulated frequency-domain seismic wavefield in accordance with one or more embodiments.

FIG. 4 illustrates a zero-offset seismic survey in accordance with one or more embodiments.

FIG. 5 illustrates a method in accordance with one or more embodiments.

FIGS. 6A and 6B display a portion of a Radon-transformed seismic wavefield in accordance with one or more embodiments.

FIG. 7 describes a method in accordance with one or more embodiments.

FIG. 8 illustrates a computer system in accordance with one or more embodiments.

FIG. 9 illustrates a drilling system in accordance with one or more embodiments.

FIG. 10 illustrates a series of systems in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a grid point” includes reference to one or more of such grid points.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

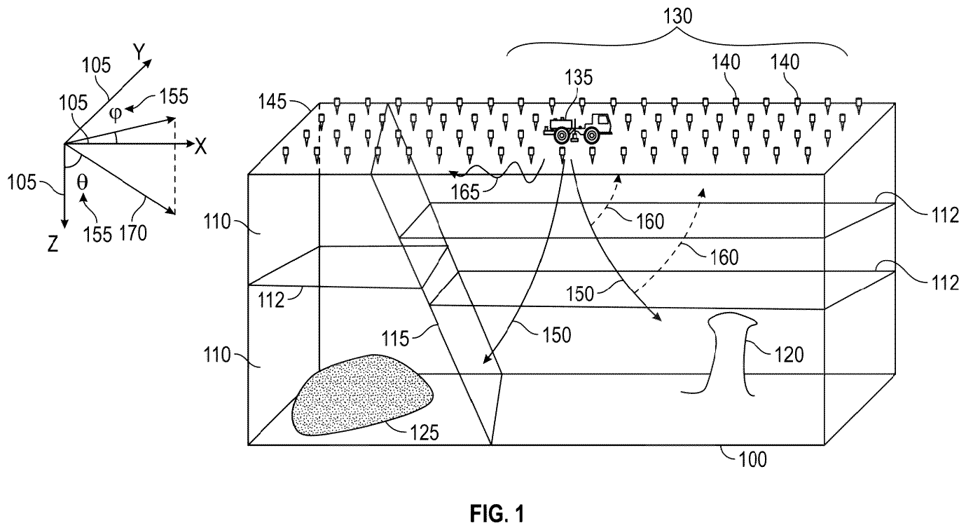

In the following description of FIGS. 1-10, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a Radon-transformed seismic wavefield, which may be considered a decomposed seismic wavefield. In the context of this disclosure, “decomposition” refers to the separation of a seismic wavefield into local plane waves based on the component angle at which seismic waves propagate through a subterranean region of interest. The Radon-transformed seismic wavefield may be used to migrate the seismic wavefield such that seismic events within the seismic wavefield are relocated. Hereinafter, the term “seismic events” may be synonymous to manifestations of geological structures, which includes manifestations of complex geological structures, within the seismic wavefield where the geological structures physically exist within the subterranean region of interest.

The disclosed method may be an improvement over ray-based methods that determine decomposed seismic wavefields as ray-based methods may compromise the accuracy of the approximation of Green's function and introduce noise into the migration result. Noise may be especially significant in seismic wavefields corresponding to complex geological structures. Further, the disclosed method may be an improvement over non-ray-based methods as decomposition into all possible angles may be computationally expensive and time consuming. Further still, the disclosed method may be an improvement over other methods, such as traditional windowed Radon transform methods that perform recalculations as recalculations may be unnecessary using the disclosed method and, thus, reduce computational expense and time.

The disclosed method relies on recursively solving the Radon transform for a frequency-domain seismic wavefield to determine a Radon-transformed seismic wavefield. Broadly speaking, recursion may be defined as a function or process that relies or calls on itself.

Turning to FIG. 1, FIG. 1 illustrates a seismic survey of a subterranean region of interest 100 in accordance with one or more embodiments. In some embodiments, the seismic survey may be used to obtain a seismic wavefield of the subterranean region of interest 100. The subterranean region of interest 100 may be defined based on a coordinate system of one or more spatial dimensions 105, denoted x, y, and z in FIG. 1. The subterranean region of interest 100 may be made up of layers of rock 110 separated by geological boundaries 112 or other geological structures, such as faults 115. The subterranean region of interest 100 may also include complex geological structures other than faults 115, such as salt domes 120. The subterranean region of interest 100 may further include a hydrocarbon reservoir 125. The hydrocarbon reservoir 125 may be rock 110 filled with fluid such as oil, gas, water, brine, and/or a combination thereof.

The seismic survey may be performed using a seismic acquisition system 130. The seismic acquisition system 130 may include a seismic source 135 and seismic receivers 140 positioned on or near the surface of the earth 145.

The seismic survey may initially rely on the seismic source 135 configured to generate radiated seismic waves 150 (i.e., emitted energy, wavefield). The radiated seismic waves 150 may propagate at specific component angles 155 (hereinafter “angles”), denoted θ and φ, as shown relative to the spatial dimensions 105 in FIG. 1. The type of seismic source 135 may depend on the environment in which it is used. For example, on land, the seismic source 135 may be a vibroseis truck or explosive charge. In water, the seismic source 135 may be an airgun. The radiated seismic waves 150 may return to the surface of the earth 145 as refracted seismic waves (not shown) or may be reflected by geological boundaries 112 or other geological structures and return to the surface of the earth 145 as reflected seismic waves 160. The radiated seismic waves 150 may also propagate along the surface of the earth 145 as Rayleigh waves or Love waves, collectively known as “ground roll” 165. Vibrations associated with ground roll 165 do not penetrate far beneath the surface of the earth 145 and, hence, are not influenced by, nor contain information about, portions of the subterranean region of interest 100 where hydrocarbon reservoirs 125 typically reside. The seismic receivers 140 located on or near the surface of the earth 145 are configured to detect radiated seismic waves 150, reflected seismic waves 160, refracted seismic waves, and ground roll 165.

Denoting the position of the seismic source 135 as (xₛ, yₛ) and the position of each seismic receiver 140 as (xᵣ, yᵣ), where x and y represent two spatial dimensions 105 on the surface of the earth 145 above the subterranean region of interest 100, the seismic trace recorded by each seismic receiver 140 may then be denoted S(xₛ, yₛ, xᵣ, yᵣ, t), where t denotes recording time (i.e., the time elapsed after the activation of the seismic source 135). The collection of all seismic traces acquired during the seismic survey may be described as a time-domain seismic wavefield.

Any method known to a person of ordinary skill in the art may be used to transform the time-domain seismic wavefield to a frequency-domain seismic wavefield. In some embodiments, a Fourier transform may be used.

In other embodiments, the frequency-domain seismic wavefield may not be determined from a seismic survey as described in FIG. 1 but may instead be immediately simulated in the frequency domain. Several methods known to a person of ordinary skill in the art may be used to generate a simulated frequency-domain seismic wavefield. Methods include, but are not limited to, a phase shift plus interpolation (PSPI) method, a phase shift method, a split-step Fourier method, and a Fourier finite-difference method. Such methods may be categorized as forward modeling methods and rely on one-way or two-way wave equations.

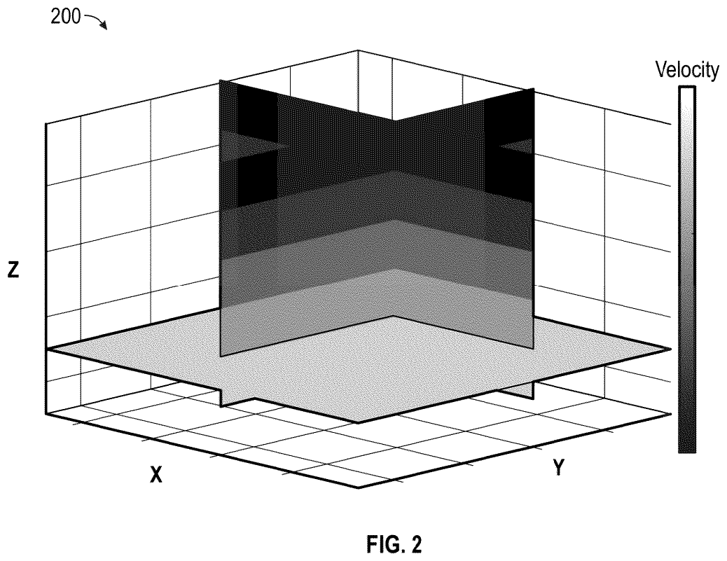

Some methods may use a seismic velocity model, at least in part, to determine the frequency-domain seismic wavefield. FIG. 2 displays a seismic velocity model 200 in accordance with one or more embodiments. FIG. 2 may be described as a laterally homogeneous seismic velocity model 200 where velocity increases as depth z increases while velocity is invariant in each horizontal (x, y) plane. However, a person of ordinary skill in the art will appreciate that the seismic velocity model 200 may take other forms that are not laterally homogeneous. As such, the form of the seismic velocity model 200 should in no way limit the present disclosure.

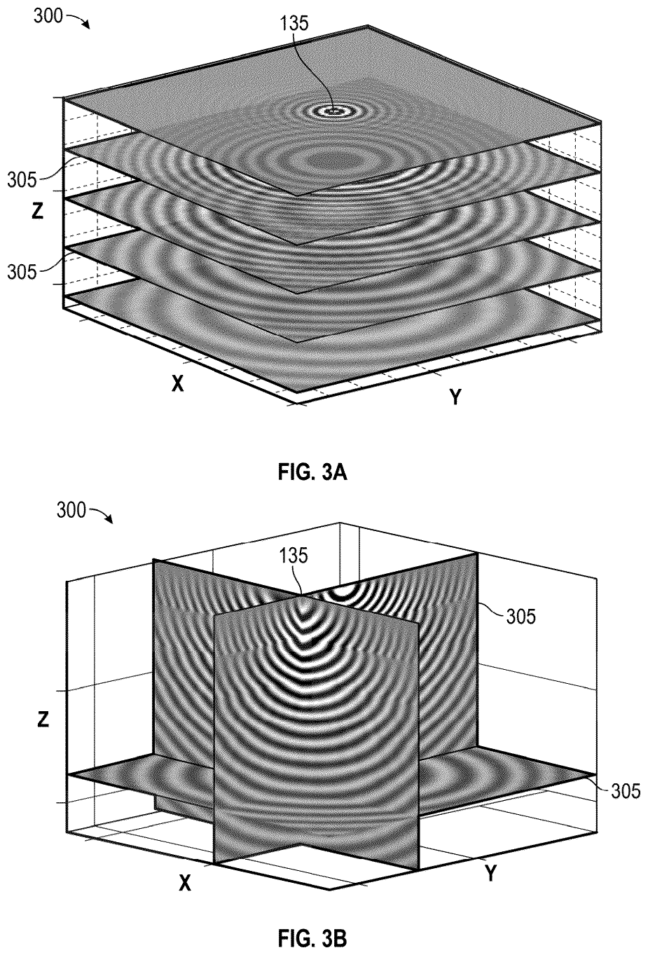

FIGS. 3A and 3B display a portion of a simulated frequency-domain seismic wavefield 300 in accordance with one or more embodiments. The simulated frequency-domain seismic wavefield 300 partially displayed in FIGS. 3A and 3B is determined using the seismic velocity model 200 displayed in FIG. 2 and a PSPI method applied to a one-way wave equation. Note that FIGS. 3A and 3B display a portion of the same simulated frequency-domain seismic wavefield 300 using different methods of display. Specifically, FIG. 3A shows a portion of the simulated frequency-domain seismic wavefield 300 displayed on five horizontal (x, y) slices 305. Whereas FIG. 3B shows a portion of the simulated frequency-domain seismic wavefield 300 displayed on two orthogonal vertical slices 305, one as an (x, z) slice 305 and one as a (y, z) slice 305, and one horizontal (x, y) slice 305. For reference, the seismic source 135 is located at the top center of the portion of the simulated frequency-domain seismic wavefield 300. Further, the seismic source 135 is simulated as a Ricker wavelet of 16 Hertz (Hz) peak frequency. Further still, only the 15 Hz component of the simulated frequency-domain seismic wavefield 300 is displayed in FIGS. 3A and 3B. Hereinafter, “frequency-domain seismic wavefield” may be used to describe either a frequency-domain seismic wavefield obtained during a seismic survey as described in reference to FIG. 1 or a simulated frequency-domain seismic wavefield 300, a portion of which is displayed in FIGS. 3A and 3B.

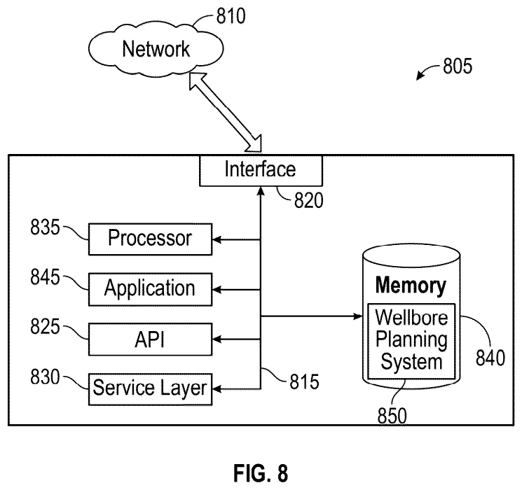

Once the seismic wavefield is obtained in any domain, the seismic wavefield may be processed using a seismic processing system, which is discussed in reference to FIG. 8. Seismic processing may be a series of processing steps that ultimately produces a frequency-domain seismic wavefield with a high signal-to-noise ratio as well as immediately useful information that may be used to characterize the subterranean region of interest 100 and locate hydrocarbon reservoirs 125 within the subterranean region of interest 100. Seismic processing may include methods of migration, stacking, filtering, etc.

In particular, migration is the process by which seismic events within the seismic wavefield are relocated. Seismic events may need to be relocated as the recorded positions of the seismic events, which correspond to geological structures with the subterranean region of interest 100, may not correspond to the true positions of the geological structures within the subterranean region of interest 100. This phenomenon may be seen as an “acoustic illusion.”

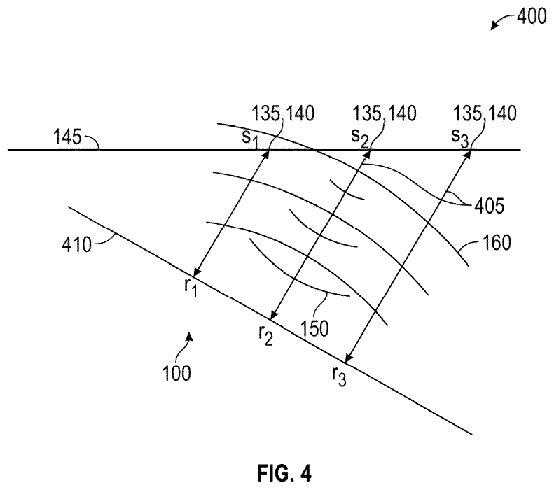

FIG. 4 illustrates why acoustic illusions may occur within a seismic wavefield acquired during a zero-offset seismic survey 400 in accordance with one or more embodiments. Here, FIG. 4 specifically shows a dip 410, which may be a fault 115, within a subterranean region of interest 100.

A zero-offset seismic survey 400 may be performed using a seismic source 135 and a seismic receiver 140 located at the same position along the surface of the earth 145, where each of three positions are denoted s₁, s₂, and s₃ in FIG. 4. At each position, the seismic source 135 emits radiated seismic waves 150 and the seismic receiver 140 records the radiated seismic waves 150 and reflected seismic waves 160 as a single seismic trace. After the seismic trace is recorded, the seismic source 135 and seismic receiver 140 are moved to the next position and the process is repeated.

As shown in FIG. 4, the seismic source 135 at s₂ emits a spherically-spreading radiated seismic wave 150 that reflects off the dip 410 at r₂ and returns to the seismic receiver 140 at s₂. The raypath 405 drawn between sᵢ and rᵢ are orthogonal to the dip 410 and hence are called “normal rays.” These raypaths 405 reveal how the zero-offset seismic survey 400 misrepresents the truth. For example, the seismic trace recorded at s₂ is dominated by the reflection near reflection point r₂. If the seismic trace corresponding to the raypath 405 traveling between s₂ and r₂ is displayed, the reflection point r₂ will be falsely displayed as though it were directly beneath s₂, which it certainly is not. This lateral mispositioning is the first part of the acoustic illusion.

The second part of the acoustic illusion is vertical in nature. If the same seismic trace corresponding to the raypath 405 traveling between s₂ and r₂ is converted to depth, the seismic trace will show r₂ to be deeper than it really is. The reason is that the slant path of the raypath 405 is longer than the vertical length from r₂ to the surface of the earth 145.

As such, migration may aim to relocate manifestations of complex geological structures, such as dips 410, to positions that correspond to their true positions within the subterranean region of interest 100. In practice, migration may be performed prior to or following stacking. Further, migration may be performed in a time domain or depth domain. Depth-domain migration may require a seismic velocity model, such as seismic velocity model 200. Types of migration include, but are not limited, Kirchhoff time migration, Kirchhoff depth migration, wave-equation migration, reverse time migration, and least-squares reverse time migration. Each method of migration may have its own unique accuracy and computational cost as well as be used to relocate specific types of geological structures. However, the method of migration used should in no way limit the scope of the disclosure.

A person of ordinary skill in the art will appreciate that other geological structures, complex or not, that manifest within the seismic wavefield may be relocated using migration. As such, the type of geology within the subterranean region of interest should in no way limit the scope of the disclosure either.

Certain methods of migration as well as other types of seismic processing steps may require a seismic wavefield to be decomposed. Here, “decomposition” refers to the separation of a seismic wavefield into local plane waves based on the angles 155 at which the radiated seismic waves 150 propagate through the subterranean region of interest 100. Types of seismic processing steps other than migration that may use a decomposed seismic wavefield include, but are not limited to, specular imaging, diffraction imaging, and angle-domain common image gathering.

Decomposition of a seismic wavefield may rely on a Radon transform. The Radon transform in a time domain may be given by:

$$g ( {x}^{′} , {y}^{′} , τ , {p}_{x} , {p}_{y} ) = {\int }_{- δy}^{+ δy} {\int }_{- δx}^{+ δx} f ( x , y , {p}_{x} ( x + {x}^{′} ) + {p}_{y} ( y + {y}^{′} ) + τ ) dxdy , \qquad ( 1 )$$

where f(x, y, t) denotes an (x, y) slice of the seismic wavefield that propagates through a three-dimensional subterranean region of interest 100 in a time domain. Here, variables δx and δy are the half width of a spatial window (hereinafter “overlapping window”) in the x and y directions, respectively, and (x′, y′) is the center of the current overlapping window. The function g(x′, y′, τ, pₓ, p_{y}) denotes the Radon-transformed seismic wavefield at (x′, y′) and the ray parameters pₓ and p_{y} are the slopes in the x and y directions, respectively.

The slopes pₓ and p_{y} are determined by:

$${p}_{x} = \frac{dt}{dx} = \frac{sin θ cos φ}{v} , \qquad ( 2 )$$

$$and$$

$${p}_{y} = \frac{dt}{dy} = \frac{sin θ sin φ}{v} , \qquad ( 3 )$$

where θ is the angle 155 between the z-axis and propagation direction 170, and φ is the azimuth angle 155 as shown in FIG. 1. Both θ and φ range from

$$- \frac{π}{2} to \frac{π}{2} .$$

The Radon transform in a frequency domain may be given by:

$$G ( {x}^{′} , {y}^{′} , {ω}_{i} , {p}_{x} , {p}_{y} ) = {\sum }_{y = - δy}^{y = + δy} {\sum }_{x = - δx}^{x = + δx} F ( {ω}_{i} , x , y ) {e}^{- i {ω}_{i} {p}_{x} ( x + {x}^{′} ) + {p}_{y} ( y + {y}^{′} )} , \qquad ( 4 )$$

where ωᵢ is the angular frequency. F and G are the Fourier-transformed data of the seismic wavefield in a time domain f(x, y, t) and the Radon-transformed seismic wavefield g(x′, y′, τ, pₓ, p_{y}) for an (x, y) slice, respectively. Hereinafter, F is referred to as the frequency-domain seismic wavefield and G, the Radon-transformed seismic wavefield.

Equation (4) may be rewritten as four separate intermediate functions:

$$A ( y , {ω}_{i} , {p}_{x} ) = {\sum }_{x = - δx}^{x = + δx} F ( {ω}_{i} , x , y ) {e}^{- i {ω}_{i} {p}_{x} x} , \qquad ( 5 )$$

$$B ( {x}^{′} , {ω}_{i} , {p}_{x} , y ) = {e}^{- i {ω}_{i} {p}_{x} {x}^{′}} A ( y , {ω}_{i} , {p}_{x} ) , \qquad ( 6 )$$

$$C ( {x}^{′} , {ω}_{i} , {p}_{x} , {p}_{y} ) = {\sum }_{y = - δy}^{y = + δy} B ( {x}^{′} , {ω}_{i} , {p}_{x} , y ) {e}^{- i {ω}_{i} {p}_{y} y} , \qquad ( 7 )$$

$$and$$

$$G ( {x}^{′} , {y}^{′} , {ω}_{i} , {p}_{x} , {p}_{y} ) = {e}^{- i {ω}_{i} {p}_{y} {y}^{′}} C ( {x}^{′} , {ω}_{i} , {p}_{x} , {p}_{y} ) . \qquad ( 8 )$$

If the spatial dimensionality of the subterranean region of interest 100 is reduced from three spatial dimensions to two spatial dimensions, equations (5)-(8) may reduce to:

$$D ( {ω}_{i} , {p}_{x} ) = {\sum }_{x = - δx}^{x = + δx} F ( {ω}_{i} , x ) {e}^{- i {ω}_{i} {p}_{x} x} , \qquad ( 9 )$$

$$and$$

$$G ( {x}^{′} , {ω}_{i} , {p}_{x} ) = {e}^{- i {ω}_{i} {p}_{x} {x}^{′}} D ( {ω}_{i} , {p}_{x} ) , \qquad ( 10 )$$

The functions A, B, C, and D may be specifically referred to as auxiliary functions. Further, each exponential term may be referred to as a phase-shifting factor. Further still, each of equations (5)-(10) may be considered a portion of a Radon transform. Depending on the number of spatial dimensions of the subterranean region of interest 100, equations (5) and (9) may each be referred to as a “first intermediate function;” equations (6) and (10), a “second intermediate function;” equation (7), a “third intermediate function;” and equation (8), a “fourth intermediate function.”

A person of ordinary skill in the art will appreciate that while equations (1) and (4)-(8) are provided in the context of an (x, y) slice of the seismic wavefield, any two-dimensional slice of the seismic wavefield may be used without departing from the scope of the disclosure.

The Radon-transformed seismic wavefield G may be determined recursively by determining values of the intermediate functions in series. To do so, the frequency-domain seismic wavefield F may be associated to grid points and those grid points organized into slices 305 and overlapping windows.

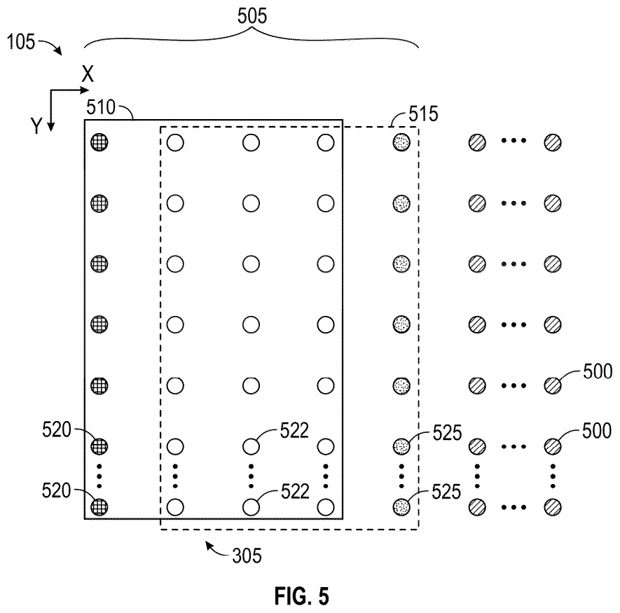

FIG. 5 illustrates a method of organization in accordance with one or more embodiments. The frequency-domain seismic wavefield F may be associated to grid points 500. The grid points 500 may represent a subterranean region of interest 100. The subterranean region of interest 100 may exist in two or three spatial dimensions 105. In turn, the grid points 500 may be organized into two or three spatial dimensions 105 to match the spatial dimensionality of the subterranean region of interest 100. The grid points 500 may be organized into any configuration with any spacing, which includes a grid-like configuration of equally-spaced grid points 500 as shown in FIG. 5, without departing from the scope of this disclosure.

Each grid point 500 may be assigned or associated with an amplitude that is a function of frequency, such as angular frequency ωᵢ, and grid point position, such as (x, y). As such, the amplitude value associated with all grid points 500 that represent the subterranean region of interest 100 may be the frequency-domain seismic wavefield F.

Returning to FIG. 5, the frequency-domain seismic wavefield F is organized into slices 305. In some embodiments, if the subterranean region of interest 100 exists in three spatial dimensions 105, each slice 305 may exist in two spatial dimensions, one of which is illustrated in FIG. 5. In other embodiments, if the subterranean region of interest 100 exists in two spatial dimensions 105, each slice 305 may exist in one spatial dimension.

Each slice 305 may be organized into a sequence of overlapping windows 505. For brevity and clarity, FIG. 5 illustrates one slice 305 organized into two overlapping windows, a first overlapping window 510 and an n-th overlapping window 515. In these embodiments, n is two though n may be any integer greater than one. In practice, the sequence of overlapping windows 505 may include tens to hundreds of overlapping windows. The sequence of overlapping windows 505 may be organized along each spatial dimension 105. As such, a slice 305 in one spatial dimension may be organized into one sequence of overlapping windows 505 along the one spatial dimension. A slice 305 in two spatial dimensions may be organized into two sequences of overlapping windows 505. The first sequence of overlapping windows 505 may be organized along the first spatial dimension and the second sequence of overlapping windows 505 may be organized along the second spatial dimension. For brevity and clarity, FIG. 5 shows a first sequence of overlapping windows 505 organized along the x dimension only. However, a second sequence of overlapping windows 505 organized along the y dimension may also exist.

Each of the sequence of overlapping windows 505 for each slice 305 includes some grid points 500. Each n-th overlapping window 515 includes common grid points 522 and incremental grid points 525 and does not include decremental grid points 520. For example, in FIG. 5, the decremental grid points 520 are not in the n-th overlapping window 515 but are in the previous overlapping window, such as the first overlapping window 510. The common grid points 522 are in the n-th overlapping window 515 and the previous overlapping window, such as the first overlapping window 510. The incremental grid points 525 are in the n-th overlapping window 515 but not the previous overlapping window, such as the first overlapping window 510.

The frequency-domain seismic wavefield F is now associated to grid points 500 and organized into slices 305 and one or more sequences of overlapping windows 505. The Radon-transformed seismic wavefield G may now be determined recursively using intermediate functions (5)-(8) or intermediate functions (9) and (10) depending on the spatial dimensionality of the subterranean region of interest 100.

Beginning with the two spatial dimensionality case, the intermediate functions (9) and (10) may be relied on. In these embodiments, the value of the auxiliary function D assigned to each grid point 500 may be considered a “value of a first intermediate function.” The value of the first intermediate function may be determined for each grid point 500 in a first overlapping window 510 by evaluating the right-hand side of the first intermediate function (9) using the amplitude value associated to the grid point 500, where the amplitude value is part of the frequency-domain seismic wavefield. Hereinafter, this process is referred to as phase 1.

Moving to the n-th overlapping window 515 in the sequence of overlapping windows 505, the value of the first intermediate function may be determined differently for each common grid point 522 and each incremental grid point 525. The value of the first intermediate function for each incremental grid point 525 may be determined as was done for each grid point 500 in the first overlapping window 510 (i.e., by evaluating the right-hand side of the first intermediate function (9) using the amplitude value associated to the incremental grid point 525 referred to as phase 1). The value of the first intermediate function for each common grid point 522 need not be re-determined as the value of the first intermediate function was previously determined for the first overlapping window 510. As such, the value of the first intermediate function at each common grid point 522 may be selected or remain as the previously-determined value of the first intermediate function. Hereinafter, this process is referred to as phase 2. Phase 2 may be repeated to determine the value of the first intermediate function for the grid points 500 in all remaining n-th overlapping windows 515 in the sequence of overlapping windows 505 for the slice 305. Phases 1 and 2 may be repeated for each slice 305.

The Radon-transformed seismic wavefield G may then be determined. To do so, a value of a second intermediate function may be determined for each grid point 500 by evaluating the right-hand side of the second intermediate function (10) using the value of the first intermediate function for the grid point 500. The value of the second intermediate function for all grid points 500 may be considered the Radon-transformed seismic wavefield G. Hereinafter, this process is referred to as phase 3.

Turning to the three spatial dimensionality case, the intermediate functions (5)-(8) may be relied on. In these embodiments, the value of the auxiliary function A assigned to each grid point 500 may be considered the value of the first intermediate function; the value of the auxiliary function B assigned to each grid point 500, the value of the second intermediate function; the value of the auxiliary function C, the value of the third intermediate function; and the value of G, the value of the fourth intermediate function.

Phases 1 and 2, as previously described, may be performed for a first sequence of overlapping windows 505 using the first intermediate function (5) to determine the value of the first intermediate function for each grid point 500. Phases 1 and 2 may be repeated for each slice 305. Phase 3, as previously described, may be performed using the second intermediate function (6) and the value of the first intermediate function for all grid points 500. Phases 1 and 2 may be performed for a second sequence of overlapping windows 505 using the third intermediate function (7) to determine the value of the third intermediate function. Phases 1 and 2 may be repeated for each slice 305. The Radon-transformed seismic wavefield G may then be determined. To do so, phase 3 may be performed using the fourth intermediate function (8) and the value of the third intermediate function for all grid points.

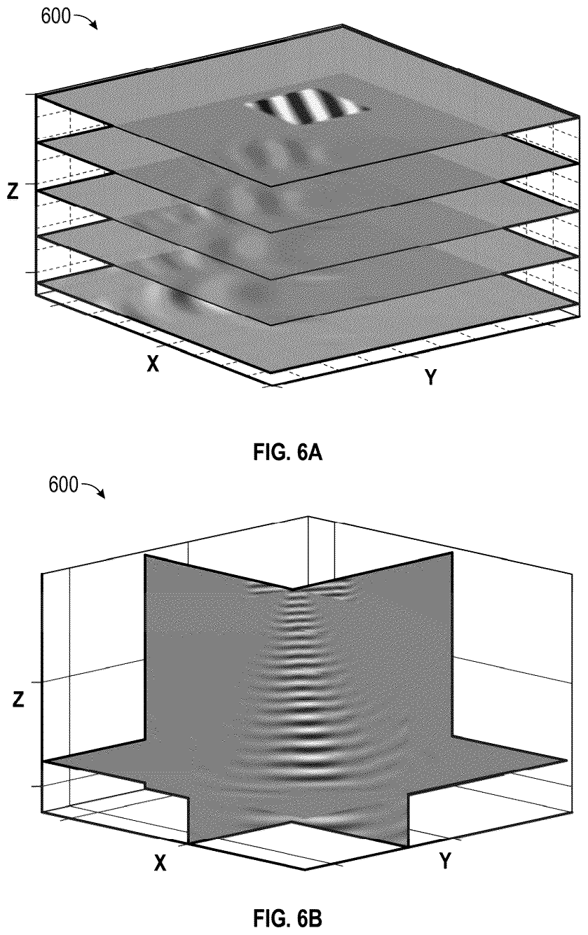

FIGS. 6A and 6B display a portion of a Radon-transformed seismic wavefield 600 in accordance with one or more embodiments. Note that FIGS. 6A and 6B display a portion of the same Radon-transformed seismic wavefield 600 using different methods of display. The Radon-transformed seismic wavefield 600 is decomposed from the simulated frequency-domain seismic wavefield 300, a portion of which is displayed in FIGS. 3A and 3B. Specifically, the portion of the Radon-transformed seismic wavefield 600 in FIGS. 6A and 6B display the Radon-transformed seismic wavefield 600 at the angles 155 of θ=−21° and φ=−21°, respectively.

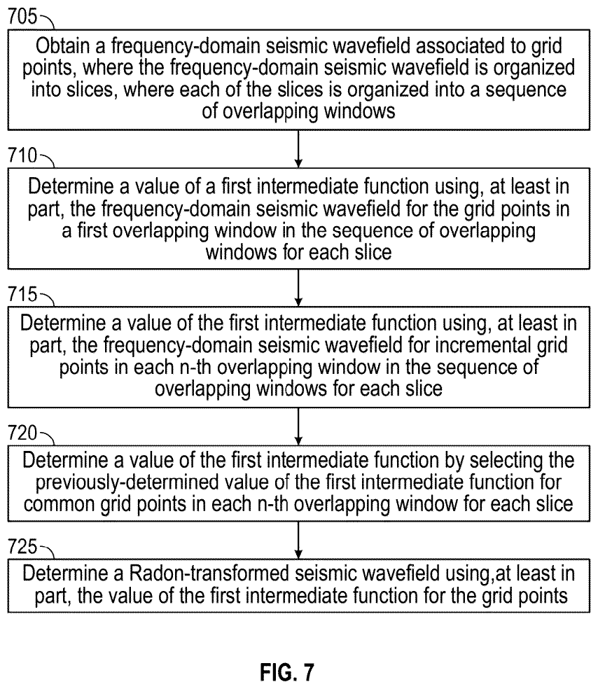

FIG. 7 describes a method in accordance with one or more embodiments. For reference, the method described herein is for the two spatial dimensionality case. As previously discussed, the method described herein may be extended to accommodate the spatial dimensionality of the subterranean region of interest 100.

In step 705, a frequency-domain seismic wavefield is obtained. In some embodiments, a time-domain seismic wavefield may be obtained from the subterranean region of interest 100 using a seismic survey as described relative to FIG. 1. In some embodiments, a Fourier transform may then be applied to the time-domain seismic wavefield to determine the frequency-domain seismic wavefield. In other embodiments, the frequency-domain seismic wavefield may be immediately simulated using any method known to a person of ordinary skill in the art, such as a PSPI method. FIGS. 3A and 3B display a portion of a simulated frequency-domain seismic wavefield 300.

The frequency-domain seismic wavefield is associated to grid points 500. That is, an amplitude value, which is a function of frequency, is associated to each grid point 500. The amplitude value associated to all grid points 500 may be the frequency-domain seismic wavefield. In practice, the frequency-domain seismic wavefield may be associated to hundreds to thousands of grid points 500.

The frequency-domain seismic wavefield is organized into slices 305. For example, FIG. 3A displays the simulated frequency-domain seismic wavefield 300 organized into five horizontal (x, y) slices 305. However, in practice, the frequency-domain seismic wavefield may be organized into tens of slices 305 in any orientation.

Each slice 305 is organized into a sequence of overlapping windows 505. The sequence of overlapping windows 505 are organized along a spatial dimension, such as spatial dimension x as shown in FIG. 5. Each overlapping window in the sequence of overlapping windows 505 overlaps with the neighboring overlapping window in the sequence of overlapping windows. For example, the first overlapping window 510 and the n-th overlapping window 515 in FIG. 5 overlap and, thus, share common grid points 522. Each n-th overlapping window 515 also includes incremental grid points 525 not shared by the previous overlapping window in the sequence of overlapping windows. Recall that n is an integer greater than one. In practice, the sequence of overlapping windows 505 may include tens to hundreds of overlapping windows.

Steps 710, 715, and 720 are performed for the grid points 500 in the sequence of overlapping windows in each slice 305. Steps 710, 715, and 720 may be performed in series. However, the serial steps may be performed for all slices 305 in parallel.

In step 710, a value of a first intermediate function is determined for each grid point 500 in the first overlapping window 510 in the sequence of overlapping windows 505. Though FIG. 5 illustrates the first overlapping window 510 residing along an edge of grid points 500, the first overlapping window 510 may reside anywhere to include any grid points 500 in the slice 305.

For the two spatial dimensionality case, the first intermediate function may be equation (9). In these embodiments, the value of the auxiliary function D is the value of the first intermediate function. The value of the first intermediate function may be determined for each grid point 500 in the first overlapping window 510 by evaluating the right-hand side of the first intermediate function (9) using the amplitude value associated to the grid point 500 (i.e., phase 1), which is part of the frequency-domain seismic wavefield.

Steps 715 and 720 are repeated for the grid points 500 in each n-th overlapping window 515 in the sequence of overlapping windows 505 in series.

In step 715, the value of the first intermediate function is determined for each incremental grid point 525 in each n-th overlapping window 515 in the sequence of overlapping windows 505. Similar to step 710, the value of the first intermediate function may be determined for each incremental grid point 525 in each n-th overlapping window 515 by evaluating the right-hand side of the first intermediate function (9) using the amplitude value associated to the incremental grid point 525 (i.e., phase 1), which is part of the frequency-domain seismic wavefield.

In step 720, the value of the first intermediate function is determined for each common grid point 522 in each n-th overlapping window 515 in the sequence of overlapping windows 505. The value of the first intermediate function for each common grid point 522 need not be re-determined as the value of the first intermediate function was previously determined for a previous overlapping window, such as the first overlapping window 510. As such, the value of the first intermediate function at each common grid point 522 may be selected as the previously-determined value of the first intermediate function (i.e., phase 2).

In step 725, a Radon-transformed seismic wavefield 600 is determined. To do so, a value of a second intermediate function may be determined for each grid point 500 by evaluating the right-hand side of the second intermediate function (10) using the value of the first intermediate function (i.e., phase 3). The value of the second intermediate function for all grid points 500 is the Radon-transformed seismic wavefield 600.

As briefly noted previously, the method described in FIG. 7 may be performed on a seismic processing system. The seismic processing system may be a computer system specifically configured for seismic processing. The seismic processing system may store and process large files, such as seismic wavefields, in a reasonable amount of time. Following the method described in FIG. 7, the seismic processing system may use the Radon-transformed seismic wavefield 600 to determine a migrated seismic image using any method of migration known to a person of ordinary skill in the art. A seismic interpretation workstation may then be used to display the migrated seismic image such that the manifestations of geological structures, such as complex geological structures, are displayed in positions that correspond to their true positions within the subterranean region of interest 100. In these embodiments, the grid points 500 represent the subterranean region of interest 100. The seismic interpretation workstation may be a computer system specifically configured for seismic interpretation. The seismic interpretation workstation may aid a seismic interpreter in determining a location of the hydrocarbon reservoir 125, for example, a depth of the hydrocarbon reservoir 125, within the subterranean region of interest 100 using the migrated seismic image.

A wellbore planning system may then be used to make a wellbore plan that includes planning a wellbore path such that, if drilled, the wellbore path would intersect the hydrocarbon reservoir 125 within the subterranean region of interest 100. The wellbore planning system may be dedicated software stored on a memory of a computer system that uses one or more processors associated to the computer system.

FIG. 8 illustrates a generic computer system 805 in accordance with one or more embodiments. As mentioned, the computer system 805 (hereinafter also “computer”) may be specifically configured for seismic processing and denoted a “seismic processing system.” Alternatively, the computer 805 may be specifically configured for seismic interpretation and denoted a “seismic interpretation workstation.” The seismic processing system, seismic interpretation workstation, or a generic computer 805 may store and be used by the wellbore planning system 850. While the generic term computer 805 may be used to describe each of the parts of a computer 805 in the following paragraphs, the terms seismic processing system or seismic interpretation workstation may replace the term computer 805 without departing from the scope of the disclosure.

The computer 805 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 805 may include an input device, such as a keypad, keyboard, touch screen, or other device that can accept user information, and an output device that displays information, including digital data, visual or audio information (or a combination of both), or a graphical user interface. Specifically, a seismic interpretation workstation may include a robust graphics card for the detailed rendering of the migrated seismic image such that the migrated seismic image may be displayed and manipulated in a virtual reality system using 3D goggles, a mouse, or a wand to identify a location of the hydrocarbon reservoir 125 within the subterranean region of interest 100.

The computer 805 can serve in a role as a client, network component, server, database, or any other component (or a combination of roles) of a computer system 805 as required for seismic processing and seismic interpretation. The illustrated computer system 805 is communicably coupled with a network 810. For example, a seismic processing system and a seismic interpretation workstation may be communicably coupled using a network 810. In some implementations, one or more components of each computer system 805 may be configured to operate within environments, including cloud-computing-based, local, global, or other environment (or a combination of environments).

At a high level, the computer system 805 is an electronic computing device operable to receive, transmit, process, store, and/or manage data and information associated with seismic processing and seismic interpretation. According to some implementations, the computer system 805 may also include or be communicably coupled with an application server, e-mail server, web server, caching server, streaming data server, business intelligence (BI) server, or other server (or a combination of servers).

Because seismic processing and seismic interpretation may not be sequential, the computer system 805 can receive requests over network 810 from other computer systems 805 or another client application and respond to the received requests by processing the requests appropriately. In addition, requests may also be sent to the computer system 805 from internal users (for example, from a command console or by other appropriate access method), external or third-parties, other automated applications, as well as any other appropriate entities, individuals, systems, or computer systems 805.

Each of the components of the computer system 805 can communicate using a system bus 815. In some implementations, any or all of the components of each computer system 805, both hardware or software (or a combination of hardware and software), may interface with each other or the interface 820 (or a combination of both) over the system bus 815 using an application programming interface (API) 1012 or a service layer 830 (or a combination of the API 825 and service layer 830. The API 825 may include specifications for routines, data structures, and object classes. The API 825 may be either computer-language independent or dependent and refer to a complete interface, a single function, or even a set of APIs. The service layer 830 provides software services to each computer system 805 or other components (whether or not illustrated) that are communicably coupled to each computer system 805. The functionality of each computer system 805 may be accessible for all service consumers using this service layer 830. Software services, such as those provided by the service layer 830, provide reusable, defined business functionalities through a defined interface. For example, the interface may be software written in JAVA, C++, or other suitable language providing data in extensible markup language (XML) format or another suitable format. While illustrated as an integrated component of each computer system 805, alternative implementations may illustrate the API 825 or the service layer 830 as stand-alone components in relation to other components of each computer system 805 or other components (whether or not illustrated) that are communicably coupled to each computer system 805. Moreover, any or all parts of the API 825 or the service layer 830 may be implemented as child or sub-modules of another software module, enterprise application, or hardware module without departing from the scope of this disclosure.

The computer system 805 includes an interface 820. Although illustrated as a single interface 820 in FIG. 8, two or more interfaces 820 may be used according to particular needs, desires, or particular implementations of each computer system 805. The interface 820 is used by each computer system 805 for communicating with other systems in a distributed environment that are connected to the network 810. Generally, the interface 820 includes logic encoded in software or hardware (or a combination of software and hardware) and operable to communicate with the network 810. More specifically, the interface 820 may include software supporting one or more communication protocols associated with communications such that the network 810 or interface's hardware is operable to communicate physical signals within and outside of the illustrated computer 805.

The computer system 805 includes at least one computer processor 835. Generally, a computer processor 835 executes any instructions, algorithms, methods, functions, processes, flows, and procedures as described above. A computer processor 835 may be a central processing unit (CPU) and/or a graphics processing unit (GPU). The seismic wavefield may be tens to hundreds of terabytes or even petabytes in size. To efficiently process the seismic wavefield to determine the Radon-transformed seismic wavefield 600 and the migrated seismic image, a seismic processing system may consist of an array of CPUs with one or more subarrays of GPUs attached to each CPU. Further, tape readers or high-capacity hard-drives may be connected to the CPUs using wide-band system buses 815.

The computer system 805 also includes a memory 840 that stores data and software for the computer system 805 or other components (or a combination of both) that can be connected to the network 810. For example, the memory 840 may store the wellbore planning system 850 in the form of dedicated software. Although illustrated as a single memory 840 in FIG. 8, two or more memories may be used according to particular needs, desires, or particular implementations of the computer system 805 and the described functionality. While memory 840 is illustrated as an integral component of each computer system 805, in alternative implementations, memory 840 can be external to each computer system 805.

The application 845 is an algorithmic software engine providing functionality according to particular needs, desires, or particular implementations of the computer system 805, particularly with respect to functionality described in this disclosure. For example, application 845 can serve as one or more components, modules, applications, etc. Further, although illustrated as a single application 845, the application 845 may be implemented as multiple applications 845 on each computer system 805. In addition, although illustrated as integral to each computer system 805, in alternative implementations, the application 845 can be external to each computer system 805.

There may be any number of computers 805 associated with, or external to, a seismic processing system and a seismic interpretation workstation, where each computer system 805 communicates over network 810. Further, the term “client,” “user,” and other appropriate terminology may be used interchangeably as appropriate without departing from the scope of this disclosure. Moreover, this disclosure contemplates that many users may use the computer system 805, or that one user may use multiple computer systems 805.

Returning to the discussion of the wellbore plan, the wellbore plan may be additionally informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore path may include a starting surface location of the wellbore, or a subsurface location within an existing wellbore, from which the wellbore may be drilled. The wellbore path may further include a terminal location that may intersect with the previously located hydrocarbon reservoir 125. The wellbore path may further still include wellbore geometry information such as wellbore diameter and inclination angle and when each of these change along the depth of the wellbore. If casing is used, the wellbore plan may include casing type or casing depths. Furthermore, the wellbore plan may consider other engineering constraints such as the maximum wellbore curvature (“dog-log”) that a drillstring of a drilling system may tolerate and the maximum torque and drag values that the drilling system may tolerate. The wellbore plan may further define associated drilling parameters, such as the planned depths at which casing will be inserted to support the wellbore to prevent formation fluids entering the wellbore and the drilling mud weights (densities) and types that may be used during drilling of the wellbore.

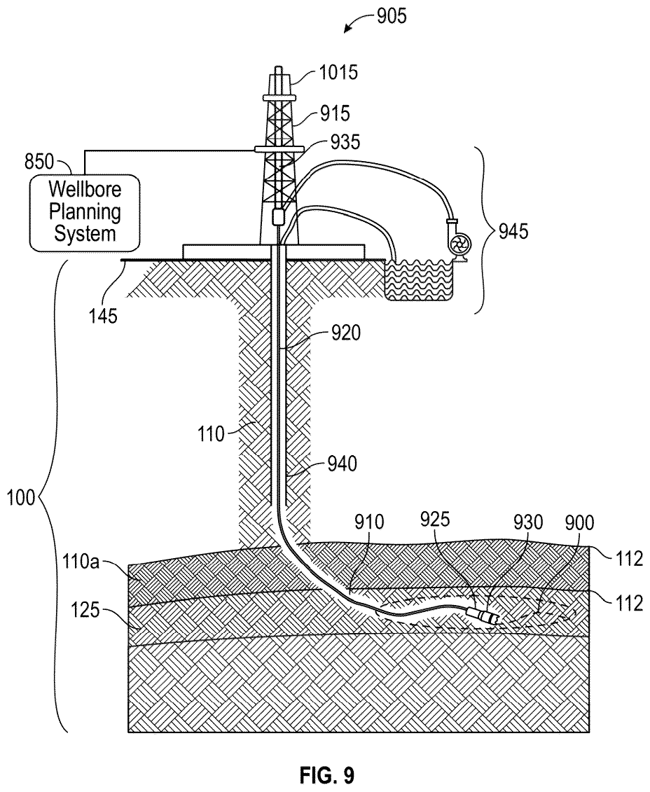

The wellbore plan may then be transferred to a drilling system 905 such that the wellbore path 900 may be drilled as illustrated in FIG. 9 in accordance with one or more embodiments. Although the drilling system 905 shown in FIG. 9 is used to drill a wellbore 910 on land, the drilling system 905 may also be a marine wellbore drilling system. The example of the drilling system 905 shown in FIG. 9 is not meant to limit the present disclosure.

As shown in FIG. 9, the wellbore 910 may be drilled using a drill rig that may be situated on a land drill site, an offshore platform, such as a jack-up rig, a semi-submersible rig, or a drill ship. The drill rig may be equipped with a hoisting system, such as a derrick 915, which can raise or lower the drillstring 920 and other tools required to drill the wellbore 910. The drillstring 920 may include one or more drill pipes connected to form conduit and a bottom hole assembly (BHA) 925 disposed at the distal end of the drillstring 920. The BHA 925 may include a drill bit 930 to cut into rock 110, including cap rock 110a. The BHA 925 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 930, the weight-on-bit, and the torque. The LWD measurements may include sensors, such as resistivity, gamma ray, and neutron density sensors, to characterize the rock 110 surrounding the wellbore 910. Both MWD and LWD measurements may be transmitted to the surface of the earth 145 using any suitable telemetry system known in the art, such as a mud-pulse or by wired-drill pipe.

To start drilling, or “spudding in,” the wellbore 910, the hoisting system lowers the drillstring 920 suspended from the derrick 915 towards the planned surface location of the wellbore 910. An engine, such as a diesel engine, may be used to supply power to the top drive 1015 to rotate the drillstring 920 via the drive shaft 935. The weight of the drillstring 920 combined with the rotational motion enables the drill bit 930 to bore the wellbore 910.

The near-surface of the subterranean region of interest 100 is typically made up of loose or soft sediment or rock 110, so large diameter casing 940 (e.g., “base pipe” or “conductor casing”) is often put in place while drilling to stabilize and isolate the wellbore 910. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth 145.

Drilling may continue without any casing 940 once deeper or more compact rock 110 is reached. While drilling, a drilling mud system 945 may pump drilling mud from a mud tank on the surface of the earth 145 through the drill pipe. Drilling mud serves various purposes, including pressure equalization, removal of rock cuttings, and drill bit cooling and lubrication.

At planned depth intervals, drilling may be paused and the drillstring 920 withdrawn from the wellbore 910. Sections of casing 940 may be connected and inserted and cemented into the wellbore 910. Casing string may be cemented in place by pumping cement and mud, separated by a “cementing plug,” from the surface of the earth 145 through the drill pipe. The cementing plug and drilling mud force the cement through the drill pipe and into the annular space between the casing 940 and the wall of the wellbore 910. Once the cement cures, drilling may recommence. The drilling process is often performed in several stages. Therefore, the drilling and casing cycle may be repeated more than once, depending on the depth of the wellbore 910 and the pressure on the walls of the wellbore 910 from surrounding rock 110.

Due to the high pressures experienced by deep wellbores 910, a blowout preventer (BOP) may be installed at the wellhead to protect the rig and environment from unplanned oil or gas releases. As the wellbore 910 becomes deeper, both successively smaller drill bits 930 and casing string may be used. Drilling deviated or horizontal wellbores 910 may require specialized drill bits 930 or drill assemblies.

The drilling system 905 may be disposed at and communicate with other systems in the well environment. The drilling system 905 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target within the hydrocarbon reservoir 125 is reached or the presence of hydrocarbons is established.

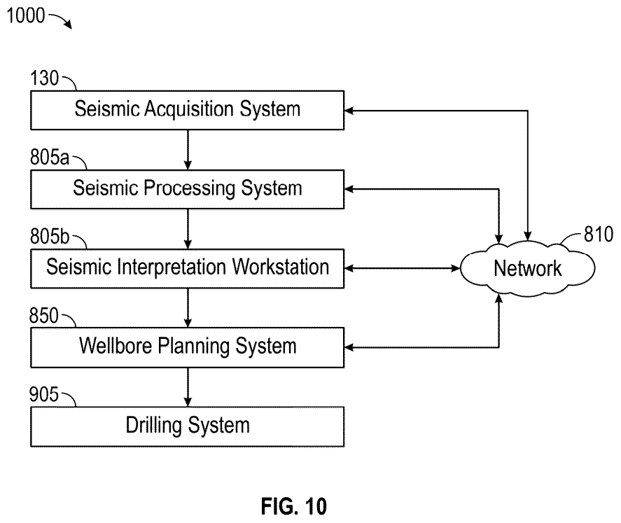

A summary of the systems 1000 associated to the method is illustrated in FIG. 10 in accordance with one or more embodiments.

In some embodiments, a seismic acquisition system 130 may be configured to obtain the seismic wavefield for the subterranean region of interest 100 as described relative to FIG. 1. In other embodiments, the seismic wavefield may be simulated using a seismic processing system 805a.

The seismic wavefield may be input into, stored on, and processed using the seismic processing system 805a as described relative to FIG. 8. Processing may include attenuating artifacts and amplifying manifestations of geological boundaries 112 and structures, such as faults 115, and the hydrocarbon reservoir 125 within the subterranean region of interest 100. Further, the seismic processing system 805a may be used to perform the methods described in the present disclosure to determine a Radon-transformed seismic wavefield 600 and to migrate the frequency-domain seismic wavefield using the Radon-transformed seismic wavefield 600.

The migrated seismic image may be transferred to and stored on the seismic interpretation workstation 805b via the network 810 as described relative to FIG. 8. The migrated seismic image may then be displayed on the seismic interpretation workstation 805b. The migrated seismic image may display the manifestations of geological structures and the hydrocarbon reservoir 125 within the subterranean region of interest 100 in positions that correspond to their true positions within the subterranean region of interest 100. A seismic interpreter may then manually manipulate the displayed migrated seismic image using the seismic interpretation workstation 805b to identify and label the manifestations of the geological structures and the hydrocarbon reservoir 125 within the subterranean region of interest 100.

The labeled migrated seismic image may then be loaded into the wellbore planning system 850 that may be located on a memory 840 of a computer 805. A user of the computer 805 may use the labeled migrated seismic image loaded into the wellbore planning system 850 to plan a wellbore path 900 that penetrates the hydrocarbon reservoir 125.

The planned wellbore path 900 may be loaded into the drilling system 905 discussed in reference to FIG. 9. The drilling system 905 may be configured to drill a wellbore 910 within the subterranean region of interest 100 guided by the planned wellbore path 900. Following drilling and completion of the wellbore 910, the wellbore 910 may be used to produce hydrocarbons from the hydrocarbon reservoir 125 to the surface of the earth 145.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining a frequency-domain seismic wavefield associated to a plurality of grid points,
wherein the frequency-domain seismic wavefield is organized into a plurality of slices,
wherein each of the plurality of slices is organized into a sequence of overlapping windows,
wherein each of the sequence of overlapping windows comprises grid points among the plurality of grid points,
wherein each n-th overlapping window in the sequence of overlapping windows comprises incremental grid points among the grid points and common grid points among the grid points, and
wherein n is an integer greater than one;
for each of the plurality of slices in turn:
for each of the grid points in a first overlapping window in the sequence of overlapping windows:
determining a value of a first intermediate function using, at least in part, the frequency-domain seismic wavefield,
for each n-th overlapping window in turn:
for each of the incremental grid points:
determining a value of the first intermediate function using, at least in part, the frequency-domain seismic wavefield,
for each of the common grid points:
determining a value of the first intermediate function by selecting the previously-determined value of the first intermediate function;
determining a Radon-transformed seismic wavefield using, at least in part, the value of the first intermediate function for the plurality of grid points.

2. The method of claim 1, further comprising:
determining a migrated seismic image using, at least in part, the frequency-domain seismic wavefield and the Radon-transformed seismic wavefield;
determining, using a seismic interpretation workstation, a location of a hydrocarbon reservoir within a subterranean region of interest using, at least in part, the migrated seismic image,
wherein the subterranean region of interest is represented by the plurality of grid points; and
planning, using a wellbore planning system, a wellbore path that penetrates the hydrocarbon reservoir.

3. The method of claim 2, further comprising drilling, using a drilling system, a wellbore guided by the wellbore path.

4. The method of claim 1, wherein the frequency-domain seismic wavefield comprises a simulated frequency-domain seismic wavefield.

5. The method of claim 4, wherein obtaining the simulated frequency-domain seismic wavefield comprises applying a phase shift plus interpolation (PSPI) method to a one-way wave equation.

6. The method of claim 1, wherein obtaining the frequency-domain seismic wavefield comprises determining, using a seismic acquisition system, the frequency-domain seismic wavefield.

7. The method of claim 1, wherein the frequency-domain seismic wavefield comprises an angular frequency-domain seismic wavefield.

8. The method of claim 1, wherein the frequency-domain seismic wavefield comprises three spatial dimensions.

9. The method of claim 1, wherein the first intermediate function comprises a portion of a Radon transform.

10. The method of claim 1, wherein determining the Radon-transformed seismic wavefield comprises using a fourth intermediate function, and
wherein the fourth intermediate function comprises a portion of a Radon transform.

11. A non-transitory computer-readable memory having computer-executable instructions stored thereon that, when executed by a computer processor, perform steps comprising:
receiving a frequency-domain seismic wavefield associated to a plurality of grid points,
wherein the frequency-domain seismic wavefield is organized into a plurality of slices,
wherein each of the plurality of slices is organized into a sequence of overlapping windows,
wherein each of the sequence of overlapping windows comprises grid points among the plurality of grid points,
wherein each n-th overlapping window in the sequence of overlapping windows comprises incremental grid points among the grid points and common grid points among the grid points, and
wherein n is an integer greater than one;
for each of the plurality of slices in turn:
for each of the grid points in a first overlapping window in the sequence of overlapping windows:
determining a value of a first intermediate function using, at least in part, the frequency-domain seismic wavefield,
for each n-th overlapping window in turn:
for each of the incremental grid points:
determining a value of the first intermediate function using, at least in part, the frequency-domain seismic wavefield,
for each of the common grid points:
determining a value of the first intermediate function by selecting the previously-determined value of the first intermediate function;
determining a Radon-transformed seismic wavefield using, at least in part, the value of the first intermediate function for the plurality of grid points.

12. The non-transitory computer-readable memory of claim 11, wherein the steps further comprise:
determining a migrated seismic image using, at least in part, the frequency-domain seismic wavefield and the Radon-transformed seismic wavefield;
determining a location of a hydrocarbon reservoir within a subterranean region of interest using, at least in part, the migrated seismic image,
wherein the subterranean region of interest is represented by the plurality of grid points; and
planning a wellbore path that penetrates the hydrocarbon reservoir.

13. The non-transitory computer-readable memory of claim 11, wherein the frequency-domain seismic wavefield comprises a simulated frequency-domain seismic wavefield.

14. The non-transitory computer-readable memory of claim 13, wherein receiving the simulated frequency-domain seismic wavefield comprises applying a phase shift plus interpolation (PSPI) method to a one-way wave equation.

15. The non-transitory computer-readable memory of claim 11, wherein the first intermediate function comprises a portion of a Radon transform.

16. A system comprising:
a seismic processing system configured to:
receive a frequency-domain seismic wavefield associated to a plurality of grid points,
wherein the frequency-domain seismic wavefield is organized into a plurality of slices,
wherein each of the plurality of slices is organized into a sequence of overlapping windows,
wherein each of the sequence of overlapping windows comprises grid points among the plurality of grid points,
wherein each n-th overlapping window in the sequence of overlapping windows comprises incremental grid points among the grid points and common grid points among the grid points, and
wherein n is an integer greater than one,
for each of the plurality of slices in turn:
for each of the grid points in a first overlapping window in the sequence of overlapping windows:
determine a value of a first intermediate function using, at least in part, the frequency-domain seismic wavefield;
for each n-th overlapping window in turn:
for each of the incremental grid points:
determine a value of the first intermediate function using, at least in part, the frequency-domain seismic wavefield;
for each of the common grid points:
determine a value of the first intermediate function by selecting the previously-determined value of the first intermediate function,
determine a Radon-transformed seismic wavefield using, at least in part, the value of the first intermediate function for the plurality of grid points, and
determine a migrated seismic image using, at least in part, the frequency-domain seismic wavefield and the Radon-transformed seismic wavefield; and
a seismic interpretation workstation configured to:
determine a location of a hydrocarbon reservoir within a subterranean region of interest using, at least in part, the migrated seismic image,
wherein the subterranean region of interest is represented by the plurality of grid points.

17. The system of claim 16, further comprising a wellbore planning system configured to plan a wellbore path that penetrates the hydrocarbon reservoir.

18. The system of claim 17, further comprising a drilling system configured to drill a wellbore guided by the wellbore path.

19. The system of claim 16, further comprising a seismic acquisition system configured to obtain the frequency-domain seismic wavefield.

20. The system of claim 16, wherein the seismic processing system is further configured to determine the frequency-domain seismic wavefield, and
wherein the frequency-domain seismic wavefield comprises a simulated frequency-domain seismic wavefield.
